(19) United States
(12) Patent Application Publication
(10) Pub. No.: US 2012/0238213 A1
(43) Pub. Date: Sep. 20, 2012

(54) CONTROL APPARATUS AND COMMUNICATION APPARATUS

(75) Inventor: Hideki OHKITA, Akishima-shi (JP)

(73) Assignee: KABUSHIKI KAISHA TOSHIBA, Tokyo (JP)

(21) Appl. No.: 13/487,808

(22) Filed: Jun. 4, 2012

Related U.S. Application Data
(63) Continuation of application No. 12/943,894, filed on Nov. 10, 2010.

(30) Foreign Application Priority Data
Dec. 18, 2009 (JP) 2009-288319

(51) Int. Cl. H04B 7/00

(52) U.S. Cl. 455/41.2

(57) ABSTRACT

According to at least one embodiment, a control apparatus includes a connection module, a communication module and a controller. A connection module is configured to connect by wire to a communication device with an antenna. A communication module is configured to communicate with a wireless communication device via the communication device. A controller is configured to instruct the communication device to report a communication state between the communication module and the wireless communication device.

### CROSS-REFERENCE TO RELATED APPLICATIONS

This application is a continuation of U.S. patent application Ser. No. 12/943,894, filed Nov. 10, 2010, which is based upon and claims the benefit of priority from Japanese Patent Application No. 2009-288319, filed Dec. 18, 2009, the entire contents of each of which are incorporated herein by reference.

### FIELD

Embodiments described herein relate generally to a technique for controlling a communication apparatus separated from a control application.

### BACKGROUND

In recent years, the techniques for transferring data between devices by wireless communication without connecting the devices by wire have been realized. One of the techniques is TransferJet (registered trademark) wireless technology.

TransferJet wireless technology has been realized by a combination of the transfer speed of ultra wideband (UWB) and the communication distance of near field communications (NFC). Accordingly, TransferJet wireless technology makes it possible to transfer large files at high speed from a mobile terminal to a personal computer (PC) by just touching a TransferJet USB (Universal Serial Bus) pad on a PC with the mobile terminal.

Jpn. Pat. Appln. KOKAI Publication No. 2009-9489 has disclosed an apparatus configured to cause an arithmetic processor provided on a communication device to control the status display of a light emitting diode (LED) capable of communicating optically with a controller according to detection operation.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary configuration of a proximity wireless system according to an embodiment.

FIG. 2 is an exemplary block diagram schematically showing a stationary device according to the embodiment.

FIG. 3 is an exemplary block diagram schematically showing a communication device according to the embodiment.

FIG. 4 is an exemplary illustration of the way the stationary device makes a connection (or disconnection) request in the embodiment.

FIG. 5 is an exemplary sequence of LED turning-on control in the embodiment.

FIG. 6 is an exemplary sequence of LED turning-off control in the embodiment.

FIG. 7 is an exemplary illustration of the way the stationary device transfers a file in the embodiment.

FIG. 8 is an exemplary sequence of LED blinking control in the embodiment.

FIG. 9 is an exemplary illustration of the way a mobile device makes a connection (or disconnection) request in the embodiment.

FIG. 10 is an exemplary sequence of LED turning-on control in the embodiment.

FIG. 11 is an exemplary sequence of LED turning-off control in the embodiment.

FIG. 12 is an exemplary illustration of the way the mobile device transfers a file in the embodiment.

FIG. 13 is an exemplary sequence of LED blinking control in the embodiment.

FIG. 14 is an exemplary flowchart to roughly explain the operation of the stationary device according to the embodiment.

FIG. 15 is an exemplary flowchart to roughly explain the operation of the communication device according to the embodiment.

FIG. 16 is an exemplary sequence to explain an LED control method using control pattern setting according to the embodiment.

FIG. 17 is an exemplary sequence to explain an LED control method using control pattern setting according to the embodiment.

FIG. 18 is an exemplary illustration of a control method using a control pattern list according to the embodiment.

FIG. 19 is an exemplary flowchart to roughly explain the operation of the communication device according to the embodiment.

FIG. 20 is an exemplary flowchart to roughly explain the operation of the stationary device according to a communication protocol of the embodiment.

### DETAILED DESCRIPTION

Various embodiments will be described hereinafter with reference to the accompanying drawings.

In general, according to one embodiment, a control apparatus includes a connection module, a communication module and a controller. A connection module is configured to connect by wire to a communication device with an antenna. A communication module is configured to communicate with a wireless communication device via the communication device. A controller is configured to instruct the communication device to report a communication state between the communication module and the wireless communication device.

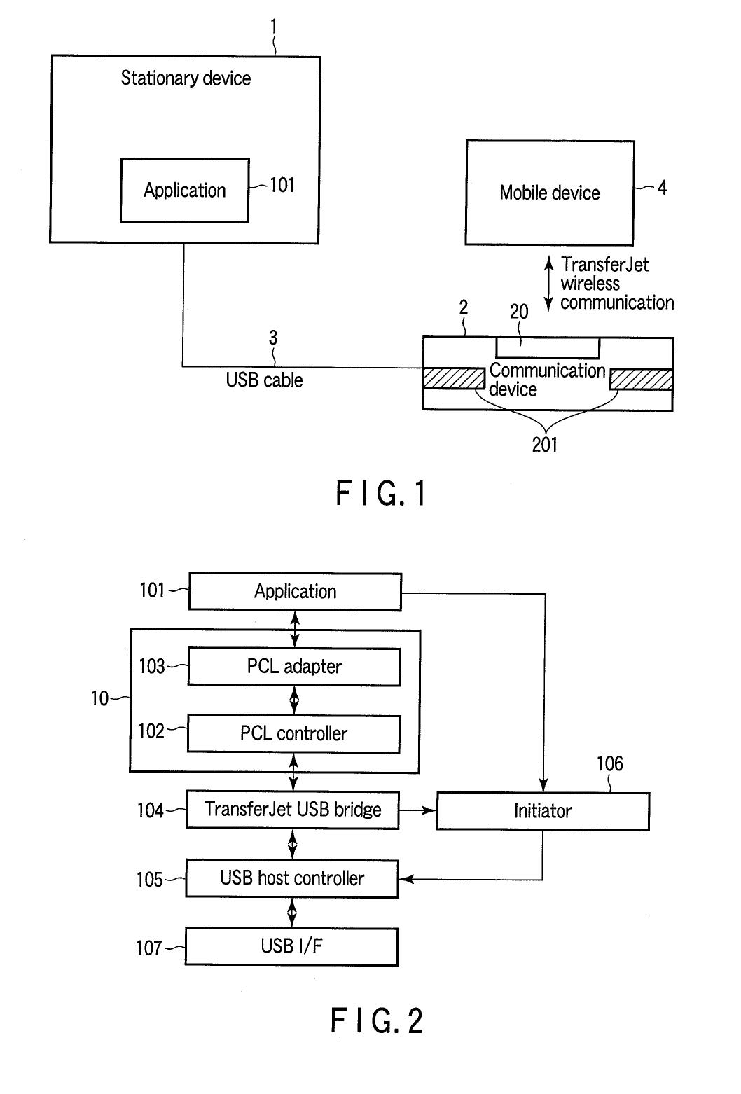

Referring to the accompanying drawings, embodiments will be explained. FIG. 1 schematically shows the configuration of a proximity wireless system according to an embodiment. The proximity wireless system includes a stationary device 1 and a communication device 2. The stationary device 1 is, for example, a personal computer. The stationary device 1 and communication device 2 are separated from each other. The stationary device 1 includes a control application 101 which controls the communication device 2. The communication device 2 is connected to the stationary device 1 with a USB cable 3 or the like. The communication device 2, which is a communication pad compatible with TransferJet wireless technology, includes an antenna (or coupler) 20 for performing TransferJet communication. The communication device 2 performs proximity wireless communication with a mobile device 4 compatible with TransferJet wireless technology, such as a mobile terminal. The communication device 2 includes an LED 201 which notifies a communication state.

FIG. 2 is a block diagram to explain the way the control application 101 is operated in the stationary device 1. A protocol conversion layer (PCL) 10 is composed of a PCL controller 102 and a PCL adapter 103. The PCL controller 102 manages sessions and controls the PCL adapter 103. The PCL adapter converts packets complying with an existing interface standard (e.g., Object exchange (OBEX) or Small computer system interface (SCSI)) into packets conforming to the TransferJet standard. A TransferJet USB bridge 104 connects with a USB host controller 105 for transmitting and receiving a signal to and from the application 101 side via the USB cable 3. The USB host controller 105 controls a USB device 202 of the communication device 2 connected to a USB interface 107. An indication control initiator 106 packetizes a control instruction for the LED 201 which notifies a communication state.

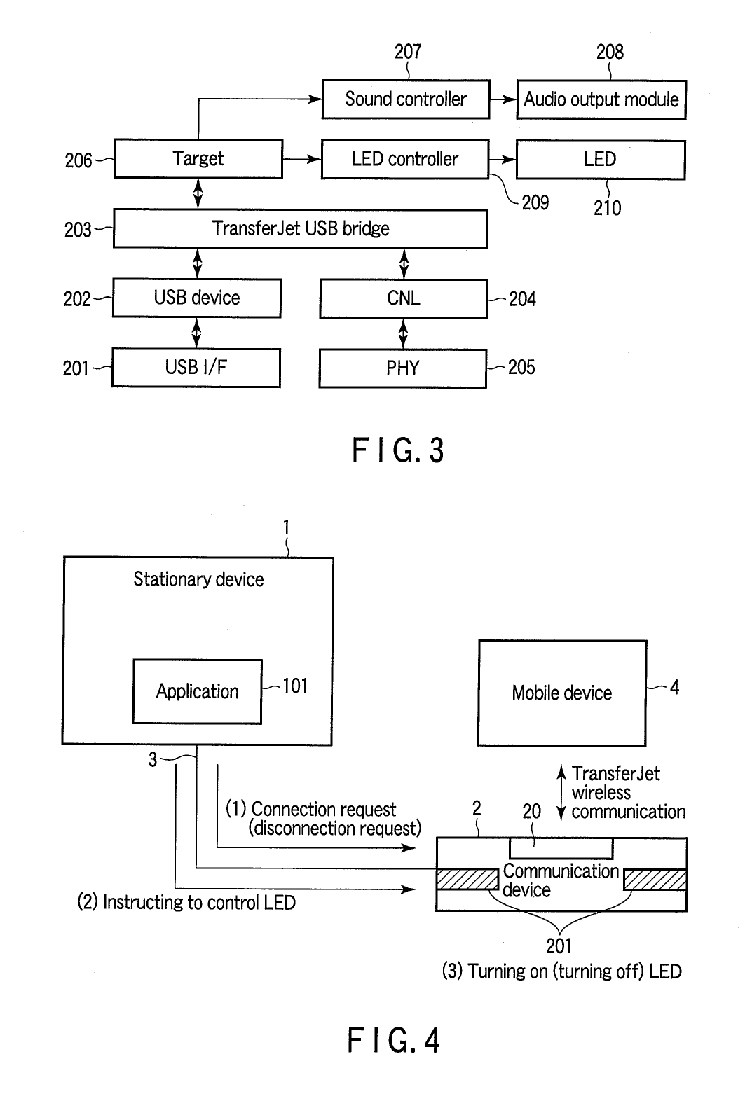

FIG. 3 is a block diagram showing the configuration of the communication device 2. The USB device 202 controls USB communication with the stationary device 1 connected to a USB interface 203. The USB device 202 makes wire connection with the stationary device 1 by use of the USB cable 3. The TransferJet USB bridge 203 connects a connection layer (CNL) 204 and a TransferJet physical layer (PHY) 205 for exchanging data with the mobile device 4 to the USB host controller 105.

The CNL 204 manages connection with the mobile device 4 and data delivery. The PHY 205 converts a signal capable of being transmitted to and received from the antenna 20 and communicates with the mobile device 4. An indication control target 206 receives a control instruction from the stationary device 1. According to an instruction 206 given by the target 206, a sound controller 207 controls an audio output module 208. An LED controller 209 controls the LED 201 according to the instruction given by the target 206.

FIG. 4 schematically shows a case where the stationary device 1 makes a connection request to the mobile device 4 in the proximity wireless system of the embodiment. The application 101 of the stationary device 1 makes a connection request to the mobile device 4 via the USB cable 3 and communication device 2. Thereafter, the application 101 transmits to the communication device 2 a turning-on instruction to perform tuning-on control of the LED 201. Receiving the turning-on instruction, the communication device 2 turns on the LED 201.

The same holds true when the stationary device 1 makes a disconnection request to the mobile device 4 to terminate the connection between the stationary device 1 and mobile device 4. That is, the application 101 makes a disconnection request to the mobile device 4 via the USB cable 3 and communication device 2. Thereafter, the application 101 transmits to the communication device 2 a turning-off instruction to perform turning-off control of the LED 201. Receiving the turning-off instruction, the communication device 2 turns off the LED 201.

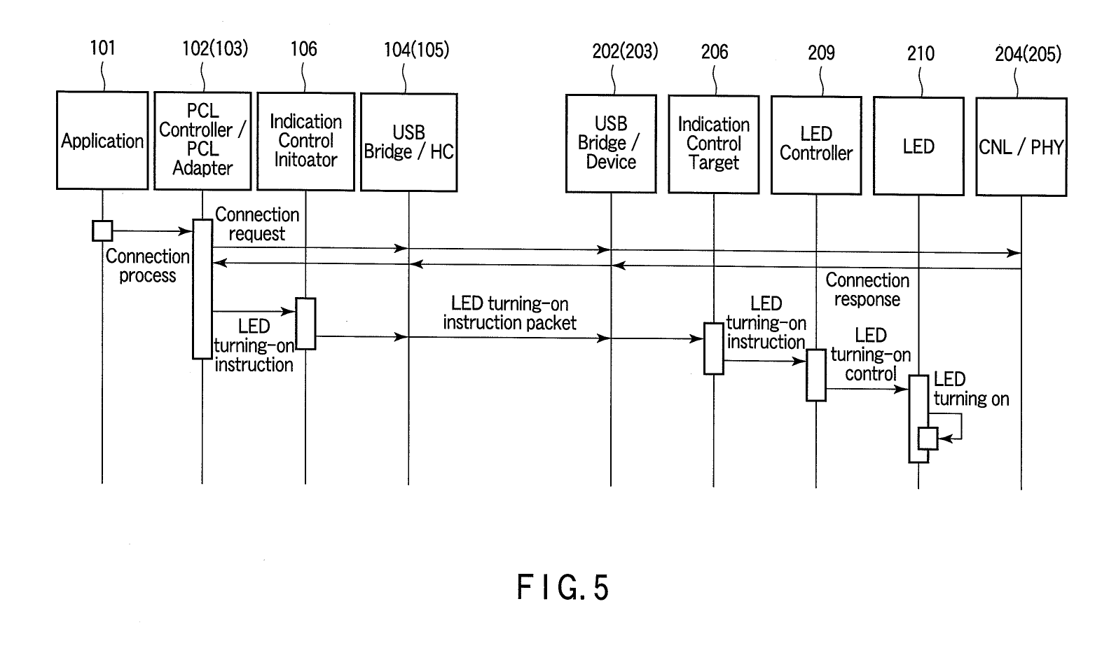

FIG. 5 shows a sequence to explain turning-on control of the LED 201 when the stationary device 1 makes a connection request to the mobile device 4 as explained in FIG. 4. According to a connection process instruction given by the application 101, the PCL controller 102 and PCL adapter 103 of the stationary device 1 transmit a connection request from the USB bridge 104 and HC 105 to the mobile device 4 via the USB cable 3 and the connection layer 204 and physical layer 205 of the communication device 2. When having received the connection request via the connection layer 204 and physical layer 205, the mobile device 4 causes the USB device 202 and USB bridge 203 to transmit a connection response to the stationary device 1 via the USB cable 3.

The PCL controller 102 and PCL adapter 103 of the stationary device 1 acquire the connection response received by the USB bridge 104 and HC 105. On the basis of the connection process instruction from the application 101, the PCL controller 102 and PCL adapter 103 transmit a turning-on instruction for the LED 201 to the initiator 106.

The initiator 106 packetizes the turning-on instruction and transmits the resulting packet to the communication device 2 via the USB cable 3. The target 206 of the communication device 2 acquires the turning-on instruction packet received by the USB device 202 and USB bridge 203. On the basis of the turning-on instruction packet, the target 206 outputs a turning-on instruction to the LED controller 209. On the basis of the turning-on instruction, the LED controller 209 performs turning-on control of the LED 201.

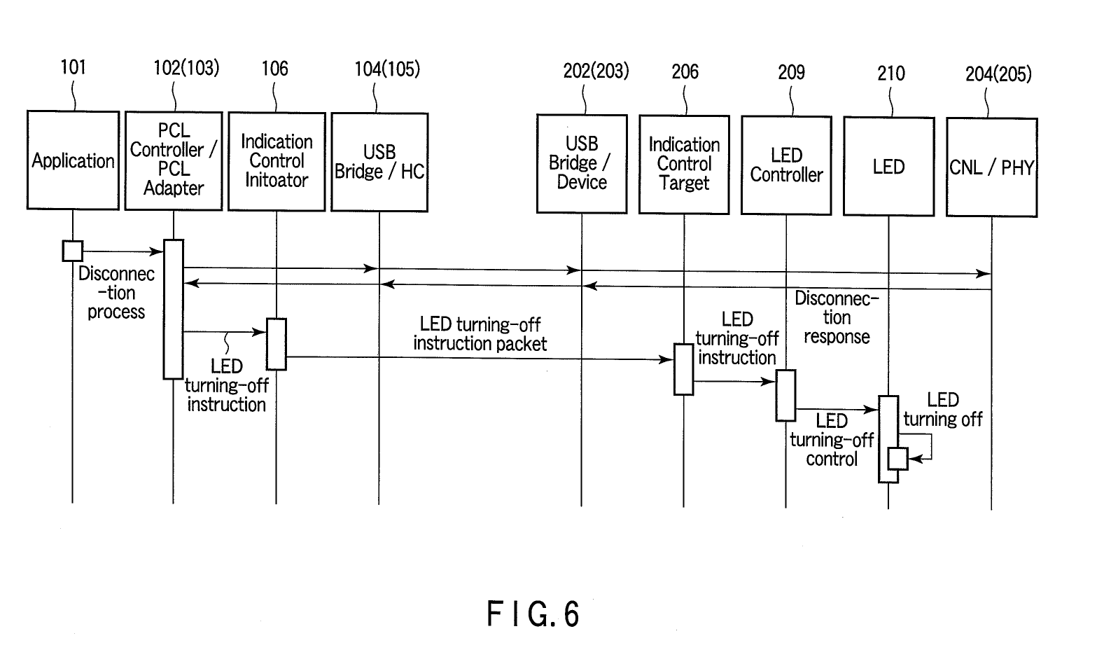

FIG. 6 shows a sequence to explain turning-off control of the LED 201 when the stationary device 1 makes a disconnection request to the mobile device 4 as explained in FIG. 4. According to a disconnection process instruction given by the application 101, the PCL controller 102 and PCL adapter 103 of the stationary device 1 transmit a disconnection request from the USB bridge 104 and HC 105 to the mobile device 4 via the USB cable 3 and the connection layer 204 and physical layer 205 of the communication device 2. When having received the disconnection request via the connection layer 204 and physical layer 205, the mobile device 4 causes the USB bridge 103 and USB device 202 to transmit a disconnection response to the stationary device 1 via the USB cable 3.

The PCL controller 102 and PCL adapter 103 of the stationary device 1 acquire the disconnection response received via the USB bridge 104 and HC 105. On the basis of the disconnection process instruction from the application 101, the PCL controller 102 and PCL adapter 103 transmit a turning-off instruction for the LED 201 to the initiator 106.

The initiator 106 packetizes the turning-off instruction and transmits the resulting packet to the communication device 2 via the USB cable 3. The target 206 of the communication device 2 acquires the turning-off instruction packet received by the USB device 202 and USB bridge 203. On the basis of the turning-off instruction packet, the target 206 outputs a turning-off instruction to the LED controller 209. On the basis of the turning-off instruction, the LED controller 209 performs turning-off control of the LED 201.

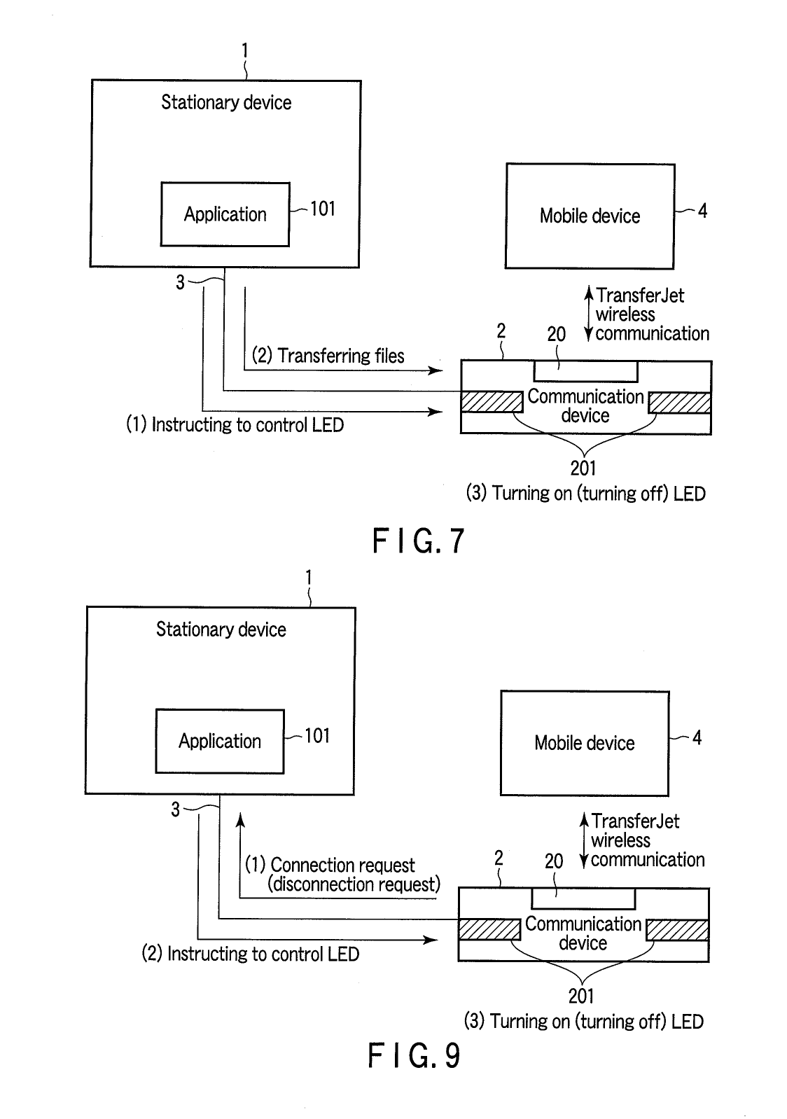

FIG. 7 schematically shows a case where the stationary device 1 transfers a file to the mobile device 4 when the stationary device 1 and mobile device 4 are coupled with each other so as to enable communication in the proximity wireless system of the embodiment. The application 101 transmits a blinking instruction for the LED 201 via the USB cable 3. Receiving the blinking instruction, the communication device 2 blinks the LED 201. Thereafter, the application 101 transfers a file to the mobile device 4 via the USB cable 3 and communication device 2.

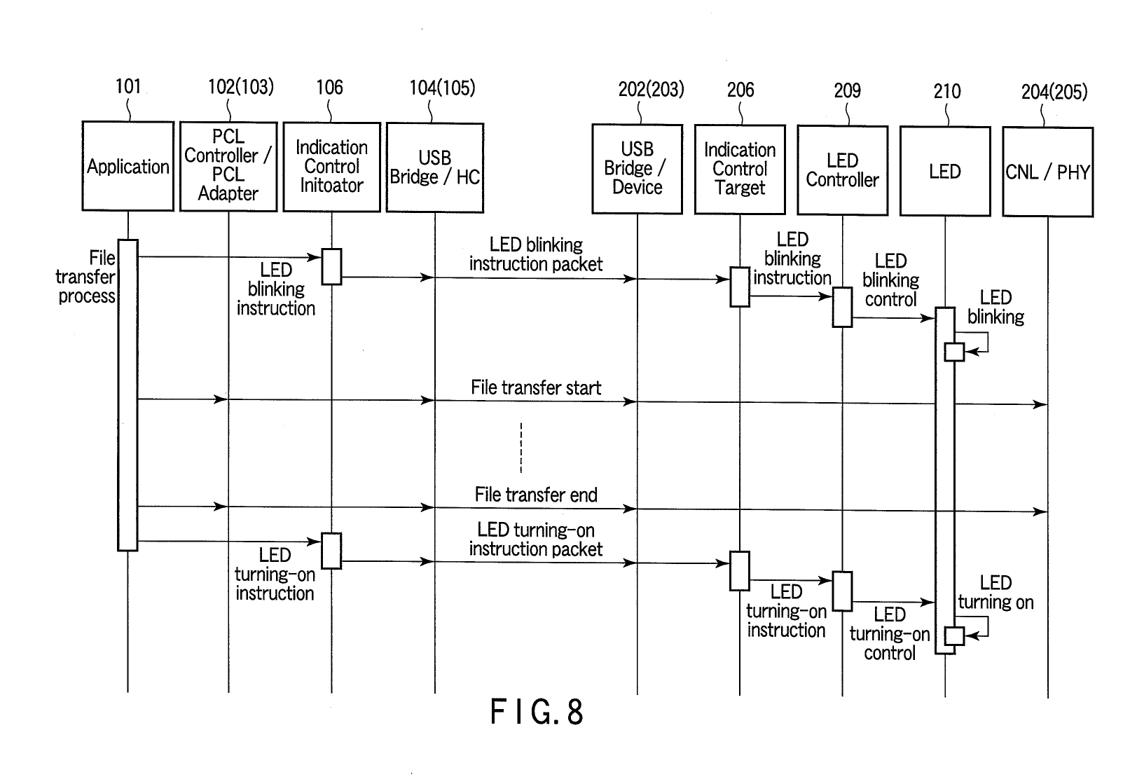

FIG. 8 shows a sequence to explain blinking control of the LED 201 when the stationary device 1 transfers a file to the mobile device 4 as explained in FIG. 7. To carry out a file transfer process, the application 101 transmits a blinking instruction for the LED 201 to the initiator 106. The initiator 106 packetizes the blinking instruction and transmits the resulting packet to the communication device 2 via the USB cable 3. The target 206 of the communication device 2 acquires the blinking instruction packet received by the USB device 201 and USB bridge 203. On the basis of the blinking instruction packet, the target 206 outputs a blinking instruction to the LED controller 209. On the basis of the blinking instruction, the LED controller 209 performs blinking control of the LED 201.

After the initiator 106 has transmitted the blinking instruction packet to the communication device 2, the application 101 starts to transfer a file to the mobile device 4 via the USB cable 3 and the connection layer 204 and physical layer 205 of the communication device 2.

After having transferred all the files to the mobile device 4, the application 101 transmits a tuning-on instruction for the LED 201 to the initiator 106. The initiator 106 packetizes the turning-on instruction and transmits the resulting packet to the communication device 2 via the USB cable 3. The target 206 of the communication device 2 acquires the turning-on instruction packet received by the USB device 202 and USB bridge 203. On the basis of the turning-on instruction packet, the target 206 outputs a turning-on instruction to the LED controller 209. On the basis of the turning-on instruction, the LED controller 209 performs turning-on control of the LED 201.

FIG. 9 schematically shows a case where the mobile device 4 makes a connection request to the stationary device 1 when the stationary device 1 and mobile device 4 are coupled with each other in the proximity wireless system of the embodiment. The mobile device 4 makes a connection request to the application 101 of the stationary device 1 via the USB cable 3 and communication device 2. Thereafter, the application 101 transmits to the communication device 2 a turning-on instruction to perform turning-on control of LED 201.

The same holds true when the mobile device 4 makes a disconnection request to the stationary device 1 to terminate the connection between the stationary device 1 and mobile device 4. That is, the mobile device 4 makes a disconnection request to the application 101 of the stationary device 1 via the USB cable 3 and communication device 2. Thereafter, the application 101 transmits to the communication device 2 a turning-off instruction for the LED 201. Receiving the turning-off instruction, the communication device 2 turns off the LED 201.

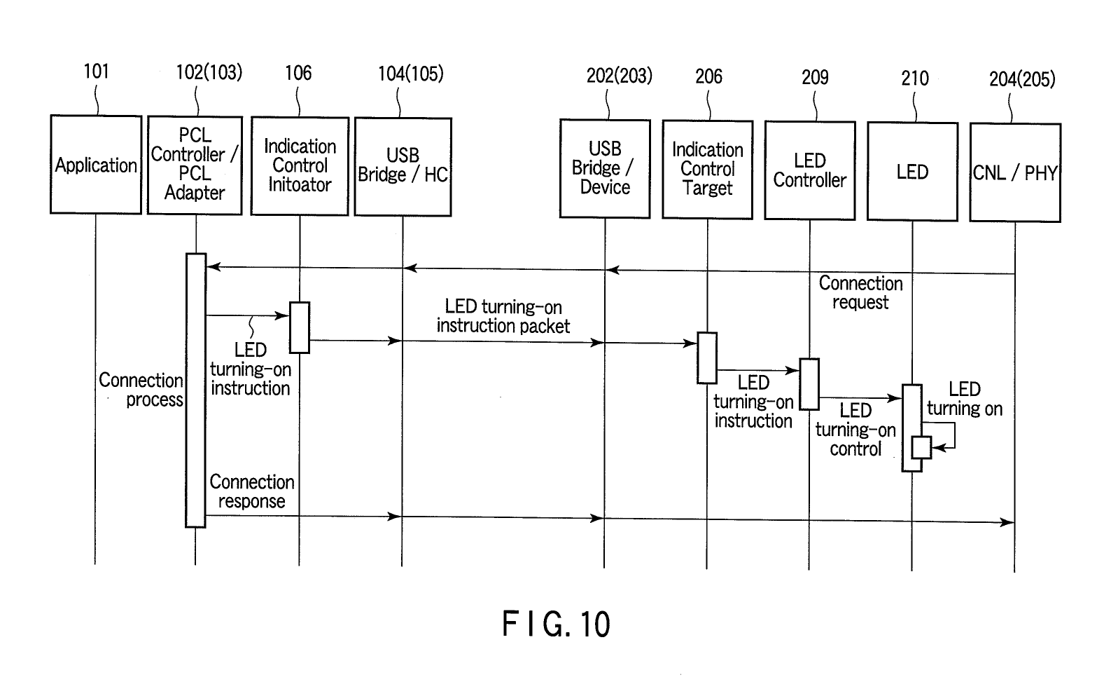

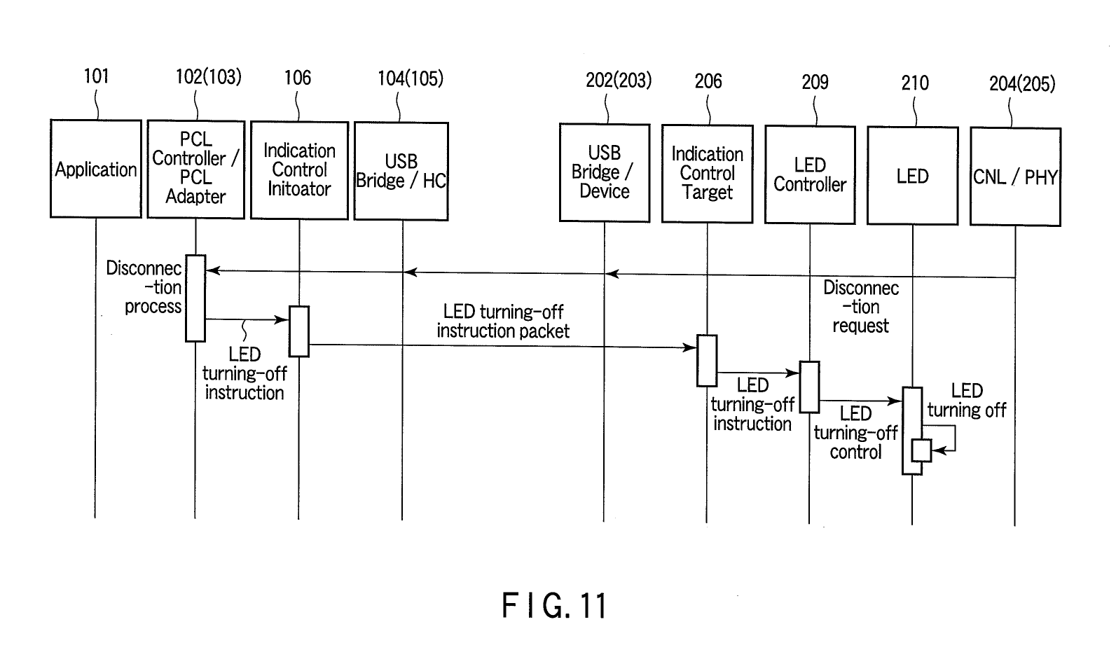

FIG. 10 shows a sequence to explain turning-on control of the LED 201 when the mobile device 4 makes a connection request to the stationary device 1 as explained in FIG. 9. The mobile device 4 communicates with the connection layer 204 and physical layer 205 of the communication device 2, thereby transmitting a connection request to the stationary device 1 via the communication device 2. When having detected the connection request from the mobile device 4, the PCL controller 102 and PCL adapter 103 of the stationary device 1 transmit to the initiator 106 a turning-on instruction for the LED 201 in response to the connection request.

The initiator 106 packetizes the turning-on instruction and transmits the resulting packet to the communication device 2 via the USB cable 3. The target 206 of the communication device 2 acquires the turning-on instruction packet received by the USB device 202 and USB bridge 203. On the basis of the turning-on instruction packet, the target 206 outputs a turning-on instruction to the LED controller 209. On the basis of the turning-on instruction, the LED controller 209 performs turning-on control of the LED 201.

After the initiator 106 has transmitted the turning-on instruction packet to the communication device 2, the PCL controller 102 and PCL adapter 103 of the stationary device 1 transmit a connection response to the mobile device 4 via the USB cable 3 and the connection layer 204 and physical layer 205 of the communication device 2.

FIG. 11 shows a sequence to explain turning-on control of the LED 201 when the mobile device 4 makes a disconnection request to the stationary device 1 as explained in FIG. 9. The mobile device 4 communicates with the connection layer 204 and physical layer 205 of the communication device 2, thereby transmitting a disconnection request to the stationary device 1 via the communication device. When having detected the disconnection request from the mobile device 4, the PCL controller 102 and PCL adapter 103 of the stationary device 1 transmit to the initiator 106 a turning-off instruction for the LED 201 in response to the disconnection request.

The initiator 106 packetizes the turning-off instruction and transmits the resulting packet to the communication device 2 via the USB cable 3. The target 206 of the communication device 2 acquires the turning-off instruction packet received by the USB device 202 and USB bridge 203. On the basis of the turning-off instruction packet, the target 206 outputs a turning-off instruction to the LED controller 209. On the basis of the turning-off instruction, the LED controller 209 performs turning-off control of the LED 201.

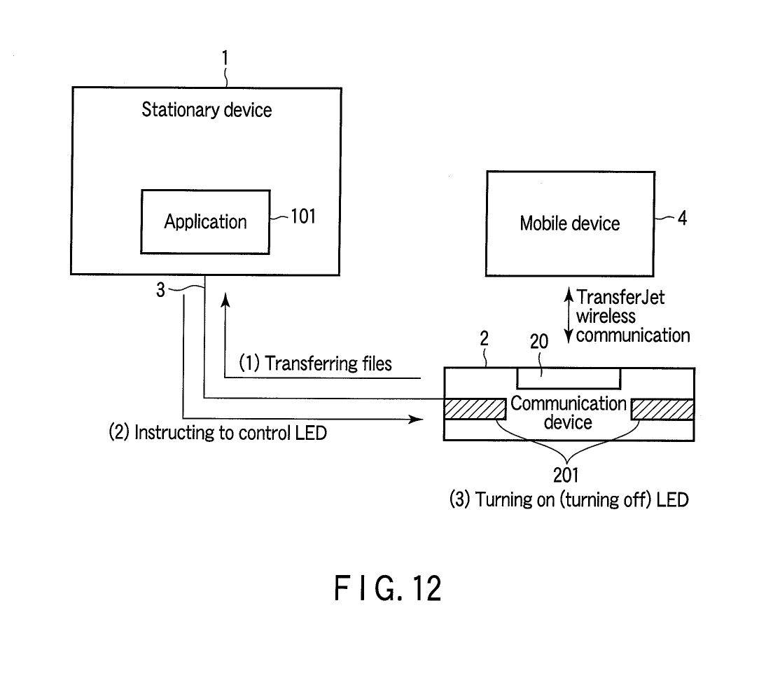

FIG. 12 schematically shows a case where the mobile device 4 transfers a file to the stationary device 1 when the stationary device 1 and mobile device 4 are coupled with each other so as to enable communication in the proximity wireless system of the embodiment. The mobile device 4 transmits a file transfer request to the application 101 via the USB cable 3 and communication device 2. When having received the file transfer request, the application 101 transmits a blinking instruction for the LED 20 via the cable 3. Receiving the blinking instruction, the communication device 2 blinks the LED 201.

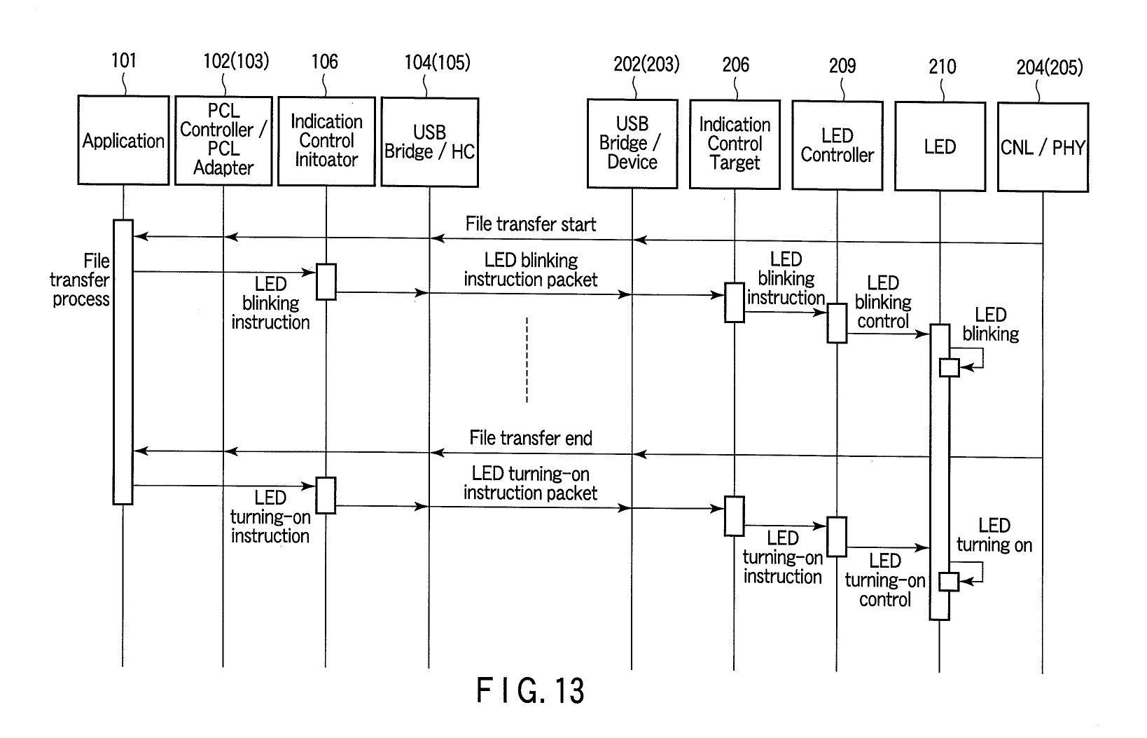

FIG. 13 shows a sequence to explain blinking control of the LED 201 when the mobile device 4 transfers a file to the stationary device 1 as explained in FIG. 12. The mobile device 4 communicates with the connection layer 204 and physical layer 205 of the stationary device 1, thereby starting a file transfer process via the USB cable 3. At the start of the file transfer process, the file transfer request is also processed.

When having detected the file transfer request from the mobile device 4, the application 101 of the stationary device 1 transmits a blinking instruction for the LED 201 to the initiator 106. The initiator 106 packetizes the blinking instruction and transmits the resulting packet to the communication device 2 via the USB cable 3. The target 206 of the communication device 2 acquires the blinking instruction packet received by the USB bridge 202 and BUS device 203. On the basis of the blinking instruction packet, the target 206 outputs a blinking instruction to the LED controller 209. On the basis of the blinking instruction, the LED controller 209 performs blinking control of the LED 201.

The mobile device 4 communicates with the connection layer 204 and physical layer 205 of the stationary device 1, thereby continuing the file transfer process via the USB cable 3. When having sensed that the mobile device 4 has completed the transfer of all the files to be transferred, the application 101 transmits a turning-on instruction for the LED 201 to the initiator 106. The initiator 106 packetizes the turning-on instruction and transmits the resulting packet to the communication device 2 via the USB cable 3. The target 206 of the communication device 2 acquires the turning-on instruction packet received by the USB bridge 202 and BUS device 203. On the basis of the turning-on instruction packet, the target 206 outputs a turning-on instruction to the LED controller 209. On the basis of the turning-on instruction, the LED controller 209 performs turning-on control of the LED 201.

Although the application 101 has transmitted a blinking instruction or a turning-on instruction for the LED 201 to the initiator 106 on the basis of the communication data transmitted from the mobile device 4, the PCL controller 102 and PCL adapter 103 may do the same thing in place of the application 101.

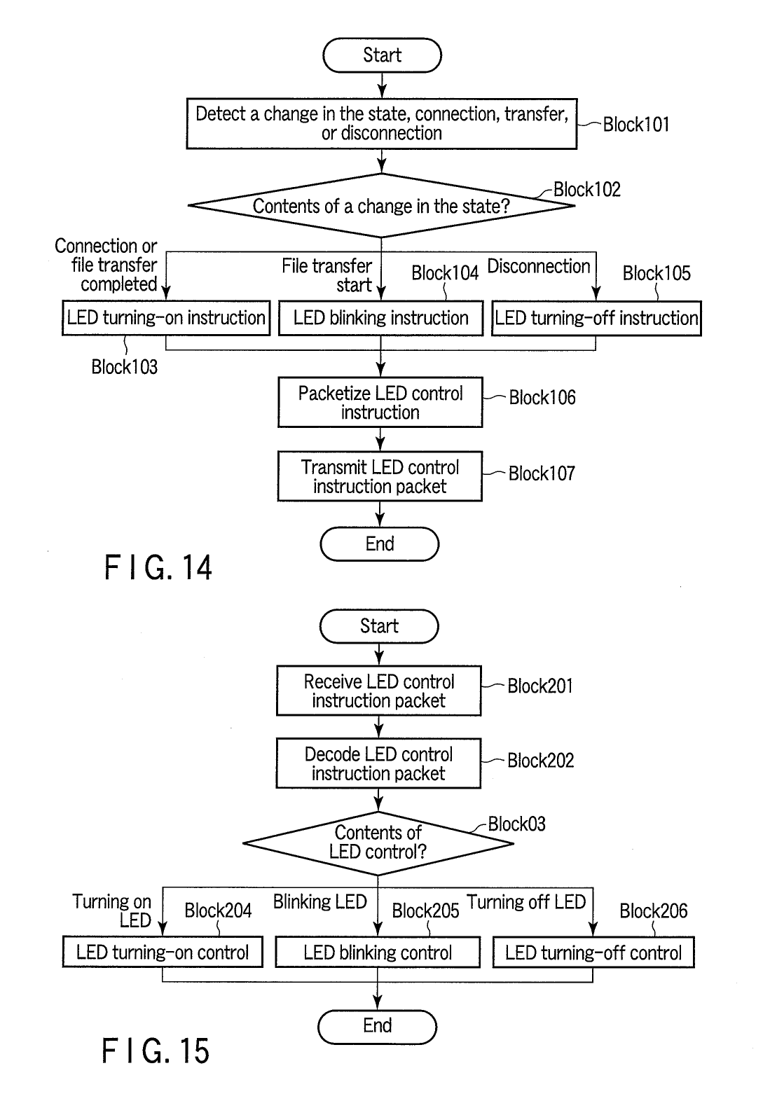

FIG. 14 is a flowchart to roughly explain the operation of the stationary device 1 side explained in FIG. 4 to FIG. 13 in the proximity wireless system according to the embodiment.

First, the application 101 detects a change in the state of communication with the mobile device 4 (block 101). A change in the communication state includes connection, file transfer, and disconnection request. According to a change in the communication state, the application 101 determines the contents of a control instruction for the LED 201 (block 102). The control instruction is one of a turning-off instruction, a turning-on instruction, and a blinking instruction explained above. Having connected with the mobile device 4 or completed the file transfer process, the application 101 determines on a turning-on instruction for the LED 201 (block 103). At the start of the file transfer process with the mobile device 4, the application 101 determines on a blinking instruction for the LED 201 (block 104). When terminating connection with the mobile device 4, the application 101 determines on a turning-off instruction for the LED 201 (block 105).

The application 101 packetizes the control instruction (block 106). Then, the application 101 transmits the control instruction packet to the communication device 2 via the USB cable 3 (block 107).

FIG. 15 is a flowchart to roughly explain the operation of the communication device 2 side explained in FIGS. 4 to 13 in the proximity wireless system of the embodiment. The target 206 receives the control instruction packet for the LED 201 (block 201). The target 206 decodes the control instruction packet (block 202). Next, the target 206 analyzes the contents of control of the LED on the basis of the control instruction (block 203).

If the contents of control are turning-on control of the LED 201, the target 206 causes the LED controller 209 to perform turning-on control of the LED 201 (block 204). If the contents of control are blinking control of the LED 201, the target 206 causes the LED controller 209 to perform blinking control of the LED 201 (block 205). If the contents of control are turning-off control of the LED 201, the target 206 causes the LED controller 209 to perform turning-off control of the LED 201 (block 206).

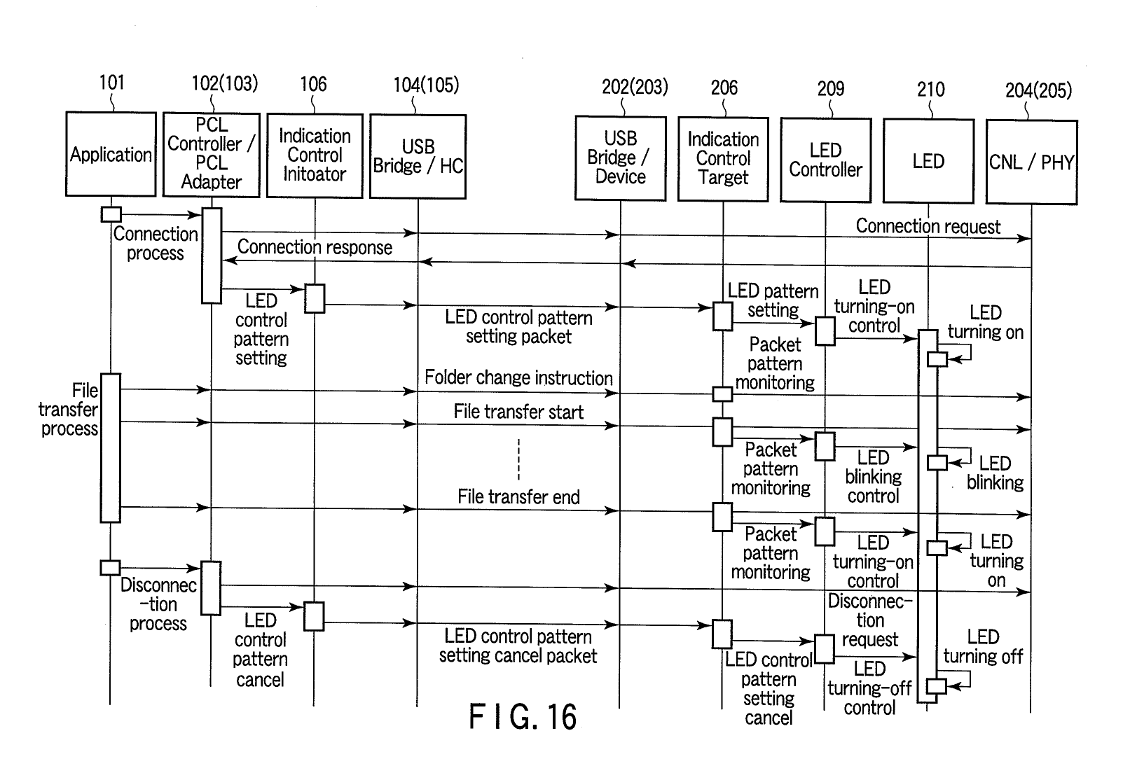

FIG. 16 shows a sequence to explain a method of controlling the LED 201 using the control pattern setting of the LED 201 when the stationary device 1 transfers a file to the mobile device 4 in the proximity wireless system of the embodiment. According to a connection process instruction from the application 101, the PCL controller 102 and PCL adapter 103 of the stationary device 1 transmit a connection request to the mobile device 4 via the USB cable 3 and the connection layer 204 and physical layer 205 of the communication device 2. Having received the connection request via the connection layer 204 and physical layer 205, the mobile device 4 transmits a connection response to the stationary device 1 via the communication device 2 and USB cable 3.

The PCL controller 102 and PCL adapter 103 of the stationary device 1 acquire the connection response received via the USB bridge 104 and HC 105. The PCL controller 102 and PCL adapter 103 of the stationary device 1 establish connection with the mobile device 4. On the basis of a control protocol determined by the application 101, the PCL controller 102 and PCL adapter 103 transmit a control pattern setting instruction to the initiator 106. The control pattern setting causes the communication device 2 to control the LED 201 on the basis of a control pattern list that associate the packet pattern of a communication data packet with a control pattern for the LED 201.

The initiator 106 packetizes the control pattern setting instruction and transmits the resulting packet to the communication device 2 via the USB cable 3. The target 206 of the communication device 2 acquires the control pattern setting instruction packet received by the USB device 202 and USB bridge 203. When having acquired the control pattern setting instruction packet, the target 206 outputs a turning-on instruction to the LED controller 209. On the basis of the turning-on instruction, the LED controller 209 performs turning-on control of the LED 201.

The target 206 monitors the communication data packet being transferred during the time when the application 101 of the stationary device 1 is transferring a file to the mobile device 4. The target 206 holds the control pattern list in advance. The target 206 compares the communication data packet with the control pattern list. If having detected a corresponding packet pattern, the target 206 controls the LED 201 according to a control pattern corresponding to the packet pattern. For example, the target 206 monitors a change in the contents of the communication data packet, thereby detecting the file transfer start time and file transfer end time.

Next, after the initiator 106 have transmitted a control pattern setting instruction to the communication device 2, the application 101 transmits to the mobile device 4 an instruction to change a folder that holds files to be transferred, via the USB cable 3 and the connection layer 204 and physical layer 205 of the communication device 2. The target 206 monitors the folder change instruction and determines not to control the LED 201 because the folder change instruction packet does not coincide with the control pattern list.

Next, the application 101 starts to transfer a file to the mobile device 4. The target 206 monitors a communication data packet of a file to be transferred. The initiator 106 compares the communication data packet of the file to be transferred with the control pattern list and, when detecting the start of the file transfer process, outputs a blinking instruction to the LED controller 209. On the basis of the blinking instruction, the LED controller 209 performs blinking control of the LED 201.

Thereafter, when the target 206 has compared the communication data packet of the file to be transferred with the control pattern list and detected the end of the file transfer process, it outputs a turning-on instruction to the LED controller 209. On the basis of the turning-on instruction, the LED controller 209 performs turning-on control of the LED 201.

The application 101 has transferred to the mobile device 4 all the files to be transferred, it transfers a disconnection process instruction to the initiator 106. On the basis of the disconnection process instruction from the application 101, the PCL controller 102 and PCL adapter 103 of the stationary device 1 transfer a disconnection request to the mobile device 4 via the USB cable 3 and the connection layer 204 and physical layer 205 of the communication device 2.

After the PCL controller 102 and PCL adapter 103 of the stationary device 1 have transferred a disconnection request to the mobile device 4, they transmit to the initiator 106 a control pattern setting cancel instruction to cancel the control pattern set in the communication device 2.

The initiator 106 packetizes the control pattern setting cancel instruction and transmits the resulting packet to the communication device 2 via the USB cable 3. The target 206 of the communication device 2 acquires the control pattern setting cancel instruction packet received by the USB bridge 202 and USB device 203. On the basis of the control pattern setting cancel instruction packet, the target 206 outputs a control pattern setting cancel instruction to the LED controller 209. On the basis of the control pattern setting cancel instruction, the LED controller 209 performs turning-off control of the LED 201.

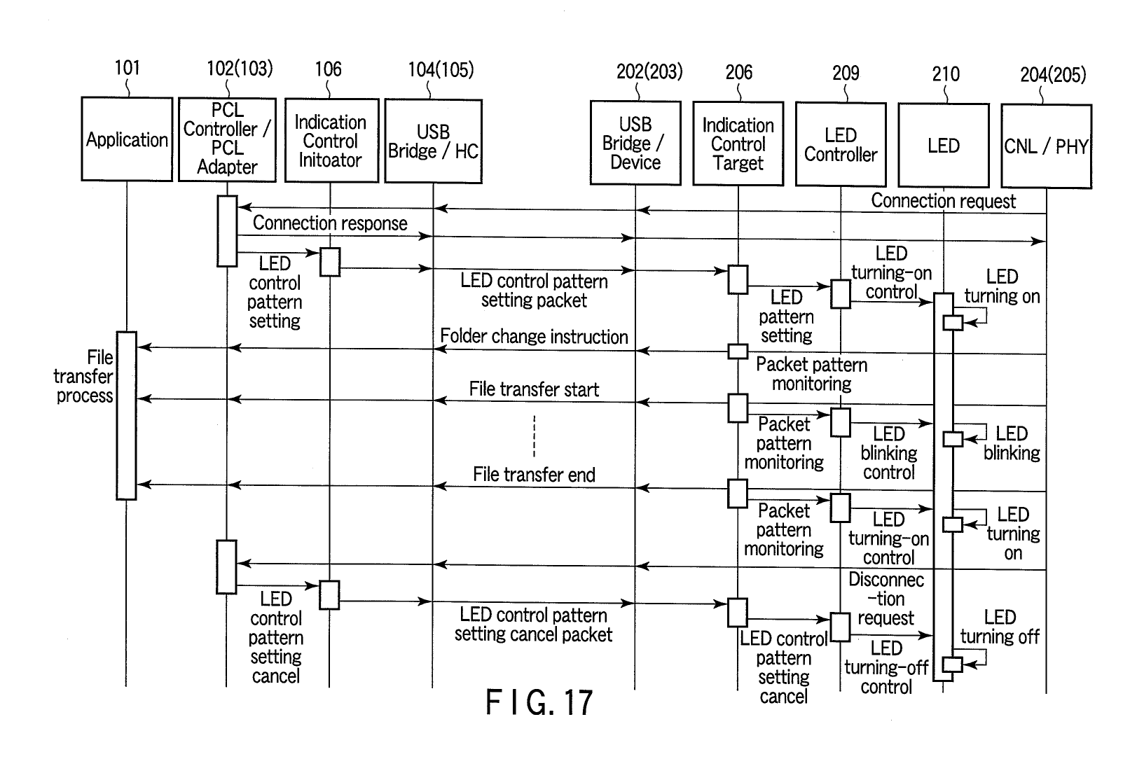

FIG. 17 shows a sequence to explain a method of controlling the LED 201 using the control pattern setting of the LED 201 when the mobile device 4 transfers a file to the stationary device 1 in the proximity wireless system of the embodiment. First, the mobile device 4 communicates with the connection layer 204 and physical layer 205 of the communication device 2, thereby transmitting a connection request to the stationary device 1 via the communication device 2. The PCL controller 102 and PCL adapter 103 of the stationary device 1 transmit a connection response to the mobile device 4 via the USB cable 3 and the connection layer 204 and physical layer 205 of the communication device 2. The mobile device 4 establishes connection with the stationary device 1.

After the PCL controller 102 and PCL adapter 103 have transmitted the connection response to the mobile device 4, they transmits a control pattern setting instruction to the initiator 106 on the basis of a control protocol determined by the application 101.

The initiator 106 packetizes the control pattern setting instruction and transmits the resulting packet to the communication device 2 via the USB cable 3. The target 206 of the communication device 2 acquires the control pattern setting instruction packet received by the USB device 202 and USB bridge 203. When having acquired the control pattern setting instruction packet, the target 206 outputs a turning-on instruction to the LED controller 209. On the basis of the turning-on instruction, the LED controller 209 performs turning-on control of the LED 201.

During the time when the mobile device 4 is transferring a file to the application 101 of the stationary device 1, the target 206 monitors the communication data packet being transferred. When the target 206 has compared the communication data packet with the control pattern list and detected a coincident packet pattern, it controls the LED 201 according to a control pattern corresponding to the packet pattern.

After the mobile device 4 has received the connection response from the stationary device 1, it starts to transfer a file. The mobile device 4 transmits a folder change instruction to the application 101 of the stationary device 1 via the USB cable 3 and the connection layer 204 and physical layer 205 of the communication device 2. The target 206 monitors the folder change instruction. Since the folder change instruction packet does not coincide with the control pattern list, the target 206 determines not to control the LED 201.

Next, the mobile device 4 starts to transfer a file to the application 101 of the stationary device 1. The target 206 monitors the communication data packet of the file to be transferred. When the target 206 has compared the communication data packet of the file to be transferred with the control packet list and detected the start of a file transfer, it outputs a blinking instruction to the LED controller 209. On the basis of the blinking instruction, the LED controller 209 performs blinking control of the LED 201.

Thereafter, when the target 206 has compared the communication data packet of the file to be transferred with the control pattern list and detected the end of the file transfer process, it outputs a turning-on instruction to the LED controller 209. On the basis of the turning-on instruction, the LED controller 209 performs turning-on control of the LED 201.

The mobile device 4 has transferred to the application 101 of the stationary device 1 all the files to be transferred, it transfers a disconnection request to the stationary device 1. On the basis of the disconnection request, the PCL controller 102 and PCL adapter 103 of the stationary device 1 transfer a control pattern setting cancel instruction to the mobile device 4.

The initiator 106 packetizes the control pattern setting cancel instruction and transmits the resulting packet to the communication device 2 via the USB cable 3. The target 206 of the communication device 2 acquires the control pattern setting cancel instruction packet received by the USB bridge 202 and USB device 203. On the basis of the control pattern setting cancel instruction packet, the target 206 outputs a control pattern setting cancel instruction to the LED controller 209. On the basis of the control pattern setting cancel instruction, the LED controller 209 performs turning-off control of the LED 201.

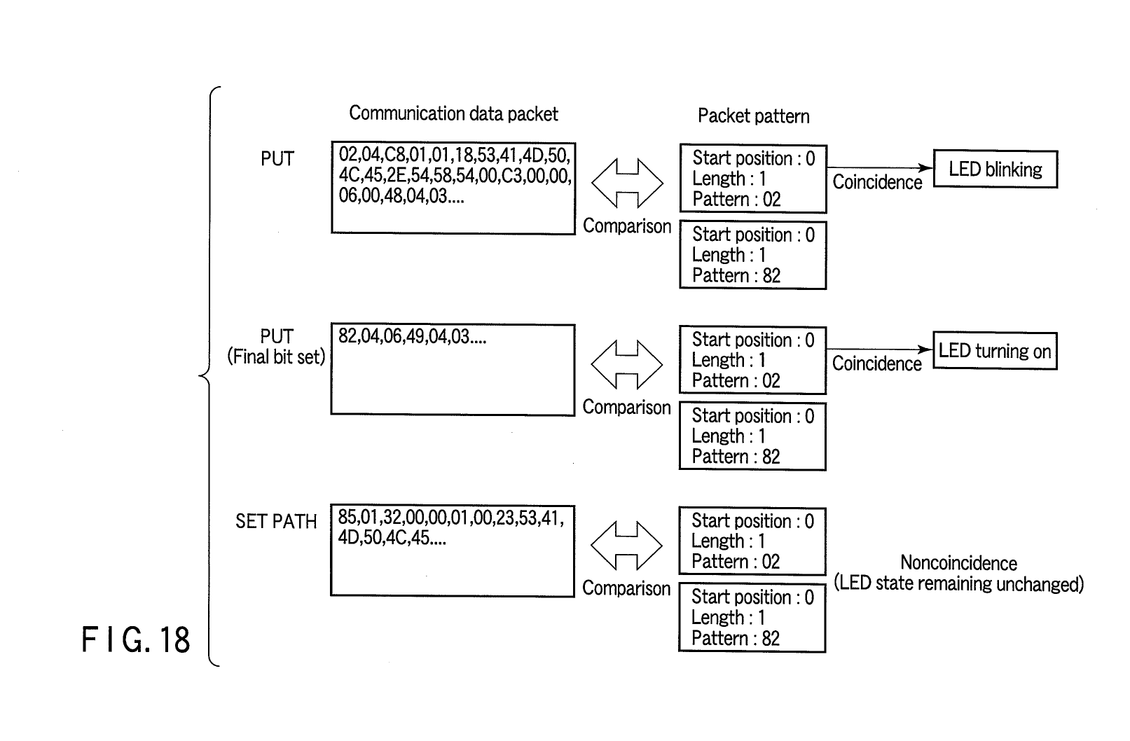

FIG. 18 schematically shows a method of controlling the LED 201 with the control device 2 using the control pattern list explained in FIGS. 16 and 17 in the proximity wireless system of the embodiment. FIG. 18 shows a case where communication data packets complying with the OBEX standard are exchanged between the stationary device 1 and mobile device 4. The control pattern list determines whether to perform blinking control or turning-on control of the LED 201, depending on whether a specified length of data from the start position of the communication data packet coincides with a specific pattern.

For example, in a PUT operation where the mobile device 4 transmits a communication data packet, the target 206 determines that the first one byte 0x02 in the communication data packet coincides with a packet pattern set so as to perform blinking control of the LED 201. The target 206 causes the LED controller 209 to perform blinking control of the LED 201. Similarly, for example, in a PUT (Final bit set) operation where the last bit set in the communication data packet is transmitted, the target 206 determines that the first one byte 0x82 in the communication data packet coincides with a packet pattern set so as to perform turning-on control of the LED 201. The target 206 causes the LED controller 209 to perform turning-on control of the LED 201. Likewise, in a SETPATH operation of changing the location of a folder that holds communication data, the target 206 determines that the first one byte in the communication data packet coincides with none of the packet patterns set so as to perform turning-on control or blinking control of the LED 201. Accordingly, the target 206 does not change the state of the LED 201.

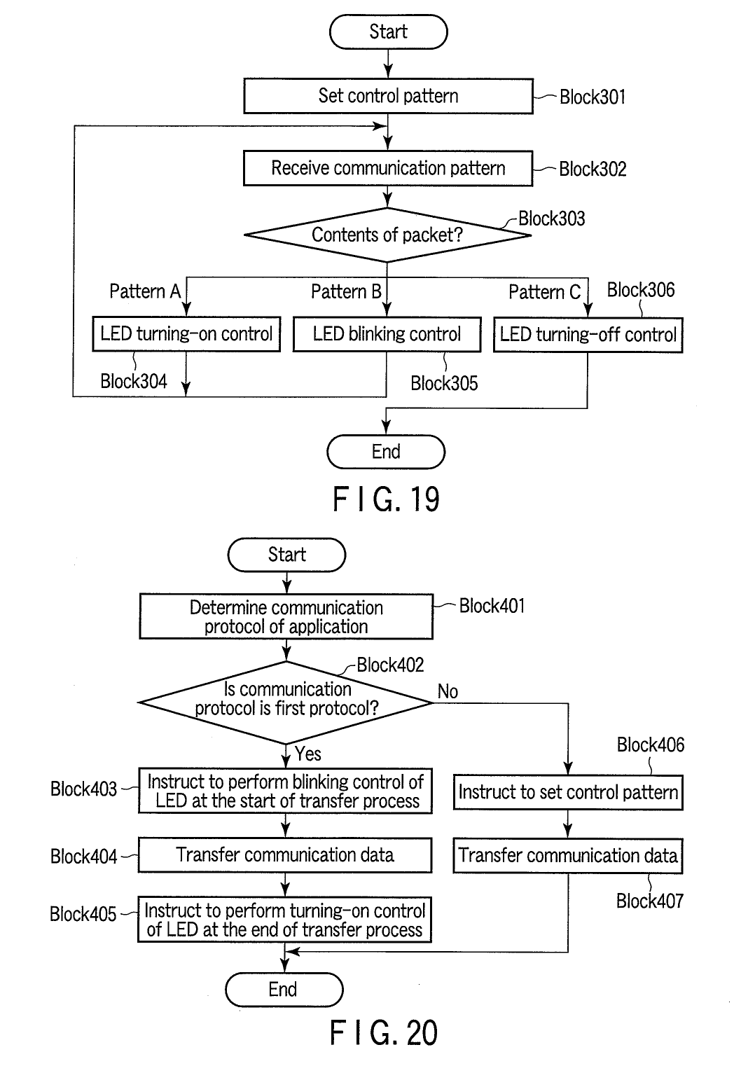

FIG. 19 is a flowchart to explain a method of controlling the LED 201 with the communication device 2 using the control pattern list explained in FIGS. 16 and 17 in the proximity wireless system of the embodiment. When having received a control pattern setting instruction, the target 206 sets the start of control of the LED 201 using the control pattern list. The target 206 monitors the communication data packet exchanged between the stationary device 1 and mobile device 4 (block 302).

The target 206 compares the communication data packet with the control pattern list (block 303). When the contents of the communication data packet coincide with pattern A, the target 206 causes the LED controller 209 to perform turning-on control of the LED 201 (block 204). The contents of a communication data packet that coincide with pattern A are, for example, the contents that represent connection with the mobile device 4 or the contents that represent the completion of a file transfer process. In this case, the target 206 returns to block 302 and continues monitoring communication data packet.

When the contents of the communication data packet coincide with pattern B, the target 206 causes the LED controller 209 to perform blinking control of the LED 201 (block 305). The contents of a communication data packet that coincide with pattern B are, for example, the contents that represent the start of the process of transferring a file to the mobile device 4. In this case, the target 206 returns to block 302 and continue monitoring communication data packet.

When the contents of the communication data packet coincide with pattern C, the target 206 causes the LED controller 209 to perform turning-off control of the LED 201 (block 306). The contents of a communication data packet that coincide with pattern C are, for example, the contents that represent disconnection from the mobile device 4. In this case, the target 206 returns to block 302 and continue monitoring communication data packet.

FIG. 20 is a flowchart to roughly explain the way the stationary device 1 changes the method of controlling the LED 201 according to the communication protocol of the communication data packet in the proximity wireless system of the embodiment.

First, the stationary device 1 determines the communication protocol of a communication data packet transferred by the application 101 (block 401). If the communication protocol is a first protocol (e.g., SCSI) (YES in block 402), the initiator 106 transmits a blinking instruction for the LED 201 to the communication device 2 at the start of a transfer process (block 403). Next, the application 101 transfers communication data to the communication device 2 (block 404). Then, the initiator 106 transmits a turning-on instruction for the LED 201 to the communication device 2 at the end of the transfer process (block 405). That is, when the communication process is the first protocol, the stationary device 1 and communication device 2 operate as explained in FIGS. 8 and 13.

If the communication protocol is not the first protocol (e.g., a second protocol is OBEX) (NO in block 402), the initiator 106 transmits a control pattern setting instruction described above to the communication device 2 before the start of the transfer process (block 406). Next, the application 101 transfers communication data to the communication device 2 (block 407).

The communication device 2 monitors the communication data packet, thereby performing blinking control of the LED 201 at the start of the transfer process and turning-on control of the LED 201 at the end of the transfer process. That is, when the communication protocol is the second protocol, the stationary device 1 and communication device 2 operate as explained in FIGS. 16 to 19.

While in the embodiment, the state of the LED 201 has been controlled according to the state of communication between the stationary device 1 and mobile device 4 (e.g., connection, file transfer process in progress, disconnection), the audio output state (e.g., prolonged sound, short duration sound, or sound effect) of the audio output module 208 may be controlled.

With the embodiment, even if the stationary device including the control application 101 is configured to be separated from the communication device 2, state display control of the LED 210 and audio output module 208 can be performed. Therefore, the user can check the state of the LED 210 or audio output module 208 in the communication device 2 to grasp the state of communication between the stationary device 1 and mobile device 4 easily.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A control apparatus comprising:
a connection module configured to connect to a first communication device by wired connection, wherein the first communication device comprises an antenna;
a communication module configured to communicate with a wireless communication device via the first communication device; and
a controller configured to instruct the first communication device to report a communication state when communicating with the wireless communication device via the first communication device according to a first communication protocol and to cause the first communication device to control reporting of the communication state when communicating with the wireless communication device via the first communication device according to a second communication protocol.

2. (canceled)

3. A communication device comprising:
an antenna, comprising a wire connection module configured to connect by wired connection to a control device;
a communication module under the control of the control device, configured to wirelessly communicate with a wireless communication device using the antenna; and
a reporting module under the control of the control device, configured to change a reporting state according to an instruction from the control device when the control device and the wireless communication device communicate with each other via the communication device in a first protocol and change the reporting state according to a pattern of a communication packet exchanged between the control device and the wireless communication device when the control device and the wireless communication device communicate with each other via the communication device in a second protocol.

4. The apparatus of claim 1, wherein the communication state is related to at least one of connection, data transfer process in progress, and disconnection.

5. The apparatus of claim 3, wherein the reporting state is related to at least one of connection, data transfer process in progress, and disconnection.
